(19) United States
(12) Patent Application Publication
(10) Pub. No.: US 2007/0260459 A1
(43) Pub. Date: Nov. 8, 2007

(54) SYSTEM AND METHOD FOR GENERATING HETEROGENEOUSLY TIED GAUSSIAN MIXTURE MODELS FOR AUTOMATIC SPEECH RECOGNITION ACOUSTIC MODELS

(75) Inventor: Qifeng Zhu, Plano, TX (US)

Correspondence Address: TEXAS INSTRUMENTS INCORPORATED, P O BOX 655474, M/S 3999, DALLAS, TX, 75265, US

(73) Assignee: Texas Instruments, Incorporated, Dallas, TX (US)

(21) Appl. No.: 11/381,576

(22) Filed: May 4, 2006

(51) Int. Cl. G10L 15/04

(52) U.S. Cl. 704/254

(57) ABSTRACT

A system for, and method of, generating an acoustic model and a heterogeneously tied mixture (HTM) acoustic model generated by means of the system and the method. In one embodiment, the system includes: (1) a first tyer configured to employ a first tying structure to tie weighted Gaussian distributions in a first pool to a first group of phones and (2) a second tyer associated with the first tyer and configured to employ a second tying structure to tie weighted Gaussian distributions in a second pool to a second group of phones, the first tying structure differing from the second tying structure, the weighted Gaussian distributions in the first pool being mutually exclusive of the weighted Gaussian distributions in the second pool, at least a criterion distinguishing the first group of phones from the second group of phones. Within each pool, different numbers of Gaussian may be assigned to different phones.

### TECHNICAL FIELD OF THE INVENTION

The invention is directed, in general, to automatic speech recognition (ASR) and, more specifically, to a system and method for generating heterogeneously tied Gaussian mixture models for ASR acoustic models.

### BACKGROUND OF THE INVENTION

With the widespread use of mobile communication devices and a need for easy-to-use human-machine interfaces, ASR has become a major research and development area. Speech is a natural way to communicate with and through mobile communication devices. Unfortunately, mobile communication devices have limited computing resources. Processor speed and memory size limit the size and power of applications that can execute within a mobile communication device, including ASR applications that would be embedded in the device. Conventional ASR applications often require a relatively large memory to contain the acoustic models they use to recognize speech.

Conventional ASR applications use Hidden Markov Models (HMMs) with Gaussian Mixture Models (GMMs) to recognize speech. Each triphone, i.e., a phone with left and right contexts, is modeled as an HMM with several states (e.g., 3 states), each having a probability distribution function (PDF). The PDF of each state is modeled by a GMM, i.e., a mixture of weighted Gaussian distributions, or “Gaussians,” represented as a mixture weight vector applied to a set of Gaussians in a Gaussian pool. For a state s, the PDF is:

$${f}_{s} ( y ) = {\sum }_{i} {w}_{i} N ( {μ}_{i } , {σ}_{i} ) ,$$

where the sum of the mixture weights equals to one, viz.:

$${\sum }_{i} {w}_{i} = 1.$$

One of the key issues in designing GMMs is how to associate the PDF of each state with corresponding Gaussians. This problem is often referred to as the “tying problem.” Several approaches have been devised to address the tying problem, each appropriate to particular environments, some to a broader range of environments than others. Four well-known categories of tying structures are as follows:
1. Un-tied mixtures. In un-tied mixtures, each state PDF has its own set of Gaussians unique to the state.
2. Fully tied mixtures. In fully tied mixtures, each state PDF is a mixture of all available Gaussians. Differences in PDFs among states is achieved by varying mixture weights corresponding to the Gaussians.
3. State-tied mixtures. In state-tied mixtures, states are pooled according to one or more criteria (e.g., triphones having the same center-phone). Gaussians are shared only within each pool.
4. Generalized tied mixtures. In generalized tied mixtures, each state points to a set of Gaussians, which is non-unique to Gaussians used in other states or sets.

Unfortunately, un-tied and fully-tied mixtures (1 and 2, above) have been found not to use HMM parameters efficiently. Thus, they are not favored. Further, the memory required to store un-tied and fully-tied mixtures is relatively great, rendering them undesirable for use in applications where memory capacity is a material constraint. As a result, state-tied and generalized tied mixtures (3 and 4, above) are preferred and consequently in wide use in modern ASR systems.

The type of tying employed is an important issue for ASR systems that are embedded in devices having limited computing resources, including mobile communication devices. The tradeoff is between ASR performance and the amount of memory required to store the GMMs.

Given this tradeoff and the resulting limitations in ASR performance given the limited amount of memory available in some environments, what is needed in the art is a new tying structure. What is also needed in the art is a method of tying that results in a GMM that requires a relatively small amount of memory, but still yields superior ASR performance.

### SUMMARY OF THE INVENTION

To address the above-discussed deficiencies of the prior art, the invention provides, in one aspect, a new tying structure and, in another aspect, a method of tying that results in a GMM that requires a relatively small amount of memory, but still yields superior ASR performance. The new tying structure will henceforth be referred to as “heterogeneously tied mixtures,” or HTM.

### BRIEF DESCRIPTION OF THE DRAWINGS

For a more complete understanding of the invention, reference is now made to the following descriptions taken in conjunction with the accompanying drawing, in which:

FIG. 1 illustrates a high-level schematic diagram of a wireless communication infrastructure containing a plurality of mobile communication devices within which the system and method of the invention can operate;

FIG. 2 illustrates generalized tying, which is employable with respect to speech triphones according to the principles of the invention;

FIG. 3 illustrates state-tying, which is employable with respect to nonspeech triphones according to the principles of the invention;

FIG. 4 illustrates Gaussians divided into speech and nonspeech pools;

FIGS. 5A and 5B together illustrate non-uniform Gaussian pruning in which, before pruning, states in the GMM have the same number of Gaussians (FIG. 5A) but, after pruning, are allowed to have different numbers of Gaussians (FIG. 5B);

FIG. 6 illustrates a heterogeneously tied mixture constructed according to the principles of the invention;

FIG. 7 illustrates a block diagram of one embodiment of a system for generating a heterogeneously tied mixture carried out according to the principles of the invention; and

FIG. 8 illustrates a flow diagram of one embodiment of a method of generating a heterogeneously tied mixture carried out according to the principles of the invention.

### DETAILED DESCRIPTION

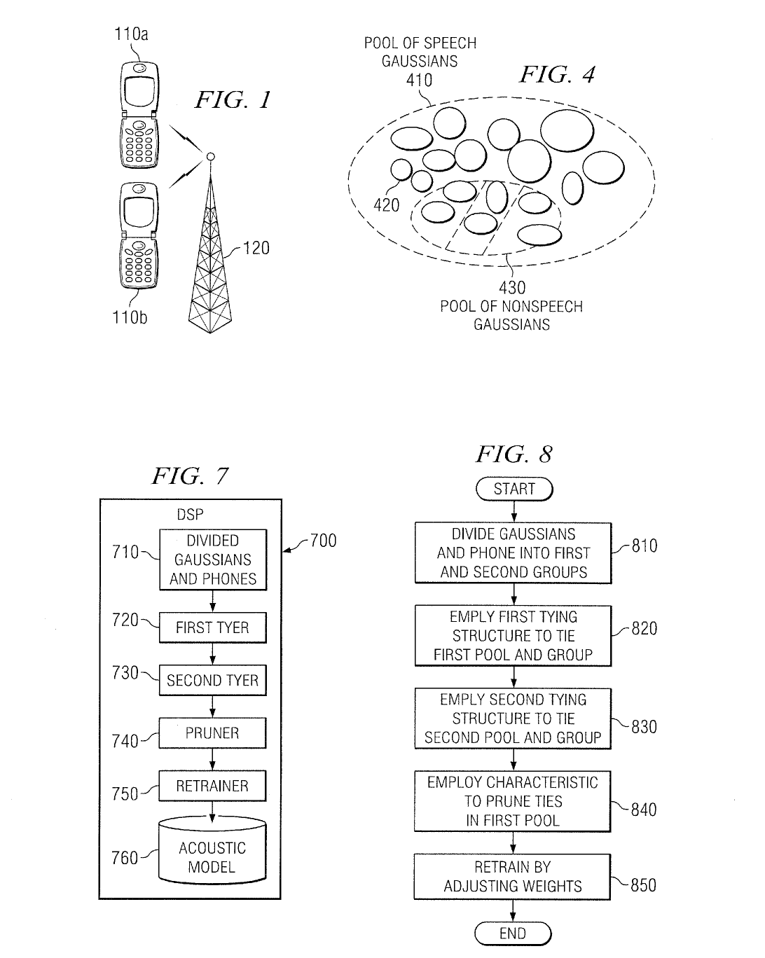

Before describing certain embodiments of the system and the method of the invention, a wireless communication infrastructure in which the novel automatic acoustic model training system and method and the underlying novel state-tying technique of the invention may be applied will be described. Accordingly, FIG. 1 illustrates a high-level schematic diagram of a wireless communication infrastructure, represented by a cellular tower 120, containing a plurality of mobile communication devices 110a, 110b within which the system and method of the invention can operate.

One advantageous application for the system or method of the invention is in conjunction with the mobile communication devices 110a, 110b. Although not shown in FIG. 1, today's mobile communication devices 110a, 110b contain limited computing resources, typically a DSP, some volatile and nonvolatile memory, a display for displaying data, a keypad for entering data, a microphone for speaking and a speaker for listening. Certain embodiments of the invention described herein are particularly suitable for operation in the DSP. The DSP may be a commercially available DSP from Texas Instruments of Dallas, Tex.

Having described an exemplary environment within which the system or the method of the invention may be employed, principles associated with certain embodiments of the invention will now be set forth. Various embodiments of HTM contain one or both of the following two novel aspects:
1. Different local constraints (e.g., generalized tying versus state-tying) are applied to different phone pools (e.g., speech versus nonspeech).
2. Different states are allowed to be tied to different numbers of Gaussians.

As described above, conventional tying structures employ the same technique in a given HMM to associate Gaussians with states. Un-tied mixtures uniformly provide a unique set of Gaussians to each state. Fully tied mixtures uniformly provide all Gaussians in a pool to all states. Even those techniques that call for states to be divided into pools use the same technique to associate Gaussians with states. For each pool, state-tied mixtures use the same Gaussians for each state in the pool. Likewise, generalized tied mixtures draw Gaussians from the same pool irrespective of the state being tied.

It has been found, however, that application of the same technique across all states is suboptimal. For example, a Gaussian used in an HMM for /a/ may be similar to another Gaussian in an HMM for /au/, but two copies of the Gaussians must nonetheless be stored. Generalized tying partially avoids this problem and thus used in HTM as a more efficient way of tying. However, generalized tying without phone constraints could lead to worse system performance due to more confusion in modeling. Instead, different techniques may be applied depending upon some characteristic that distinguishes one pool from another.

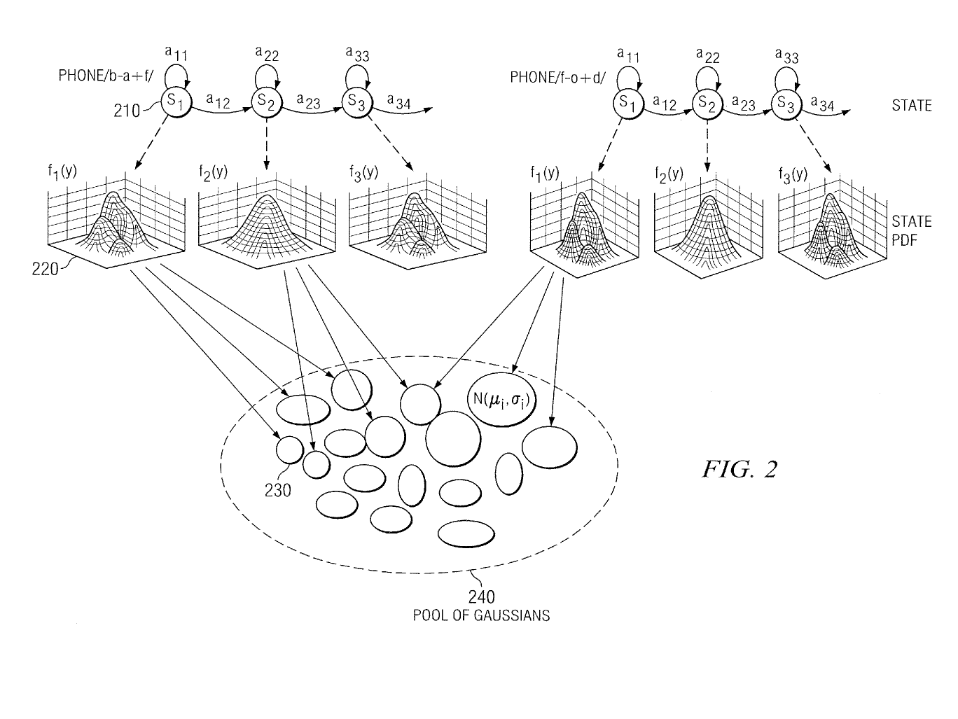

It has been discovered that adding a constraint, e.g., treating speech phones and nonspeech phones differently, can significantly improve system performance. Accordingly, in one embodiment to be illustrated and described in conjunction with FIGS. 2, 3 and 4, states are divided into two pools, one containing speech states and the other containing nonspeech states.

A generalized tied mixture technique is applied to the speech states. FIG. 2 illustrates generalized tying, which is employable with respect to speech triphones according to the principles of the invention. In generalized tying, a state of a given triphone (e.g., a state 210) has an associated PDF (e.g., a PDF 220). The PDF is formed by a superposition of Gaussians (e.g., including a Gaussian 230). The Gaussians are selected from a pool 240 that includes all Gaussians available to all states. Those skilled in the pertinent art understand how generalized tying may be used to associate states with Gaussians. However, those skilled in the pertinent art have not heretofore considered using generalized tying in combination with one or more other tying structures.

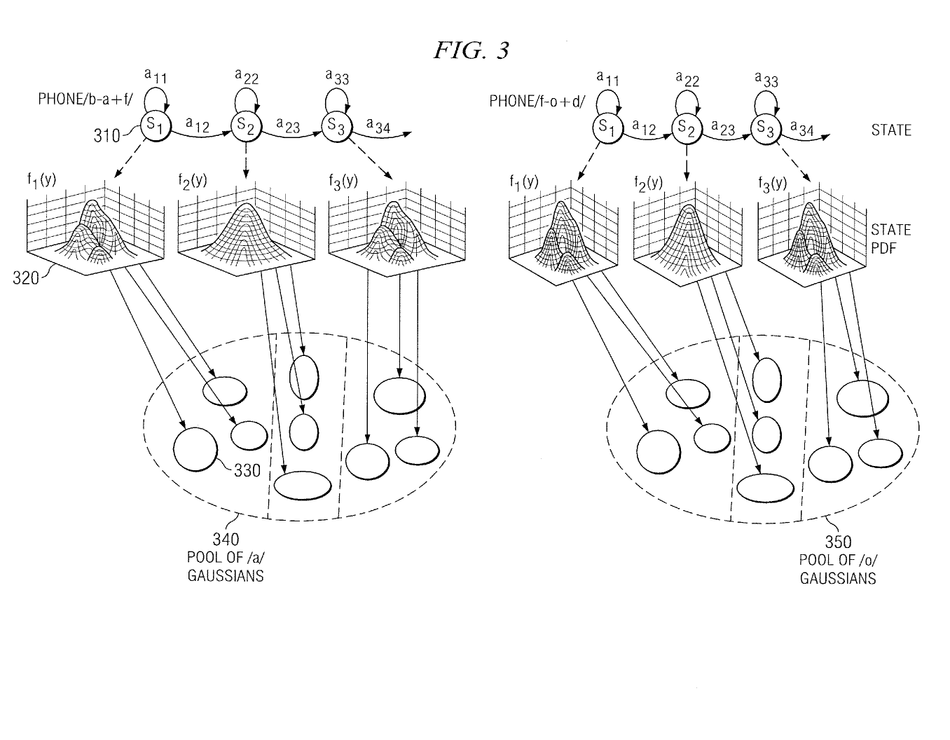

A state-tied technique is applied to the nonspeech states. FIG. 3 illustrates state-tying, which is employable with respect to nonspeech triphones according to the principles of the invention. In state-tying, a state of a given triphone (e.g., a state 310) has an associated PDF (e.g., a PDF 320). The PDF is formed by a superposition of Gaussians (e.g., including a Gaussian 330). The Gaussians contained in a pool 340 that includes only Gaussians pertaining to phones having an /a/ centerphone. A separate pool 350 includes only Gaussians pertaining to phones having an /o/ centerphone. Gaussians in the pool 350 are not available to triphones having an /a/ centerphone. Those skilled in the pertinent art understand how state-tying may be used to associate states with Gaussians. However, those skilled in the pertinent art have not heretofore considered using state-tying in combination with one or more other tying structures.

FIG. 4 illustrates Gaussians divided into speech and nonspeech pools. The Gaussians in a superset of Gaussians 410 are tagged as either speech Gaussians 420 or nonspeech Gaussians 430. In the illustrated embodiment, the speech Gaussians 420 and the nonspeech Gaussians 430 are mutually exclusive. For the HMMs of speech phones, generalized tying is applied using the speech Gaussians 420. For the HMMs for nonspeech phones, each state has it unique set of nonspeech Gaussians 430.

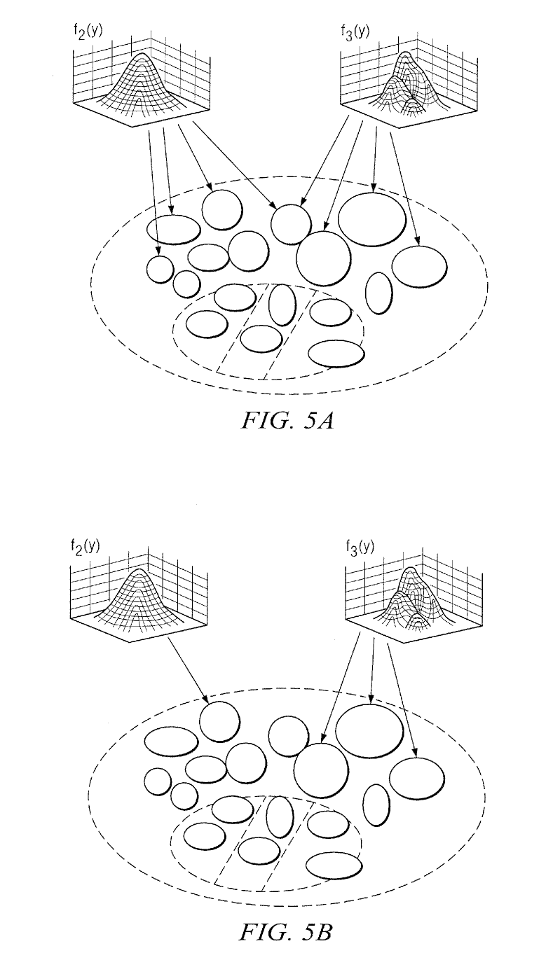

Some embodiments of HTM allow different states to have different number of Gaussians. This allows only the significant Gaussians are kept, thus improves the efficiency of the model. One process by which this may be achieved is pruning. FIGS. 5A and 5B together illustrate non-uniform Gaussian pruning in which, before pruning, states in the GMM have the same number of Gaussians (FIG. 5A) but, after pruning, are allowed to have different numbers of Gaussians (FIG. 5B).

Referring first to FIG. 5A, a fixed number of Gaussians, e.g. 5, may first be allocated to each state. This allocation may be performed in a conventional way, e.g., via a pooling algorithm. Then Gaussians having a mixture weight below a predetermined threshold may be pruned. This may be thought of as pruning based on weight magnitude. It has been found empirically that a threshold resulting in the lowest 20% of all the mixture weights being pruned provides an advantageous result. As is conventional, retraining may be applied after the Gaussian pruning.

An alternative way of Gaussian pruning is distance-based pruning, where Gaussians far from the center of the state are pruned out using a threshold. Those skilled in the pertinent art are familiar with distance pruning, which is outside the scope of the present discussion.

It has been found that the vowels, such as /a/ or /er/, often require more Gaussians to build good models. For consonants, such as /sh/ or /s/, one Gaussian may suffice.

Finally, it should be noted that FIGS. 5A and 5B only show pruning with respect to speech Gaussians and their corresponding phones. Pruning may occur with respect to nonspeech Gaussians and their corresponding phones or other pools of Gaussians as may be present in a particular application, provided that the tying structure associated with the pool in question accommodates pruning.

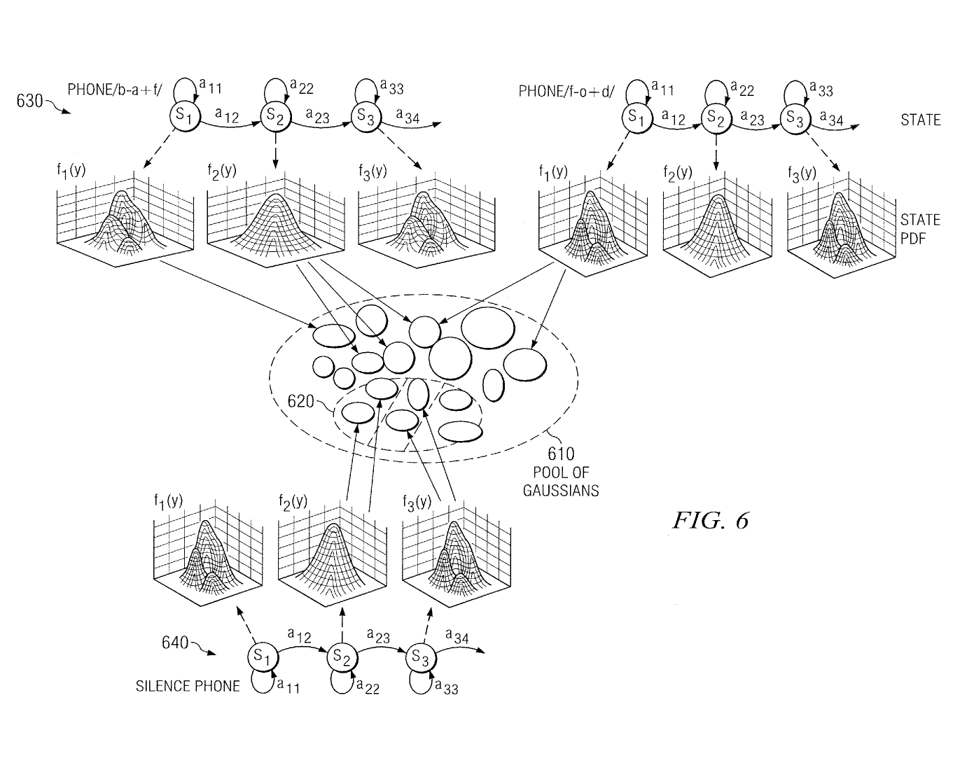

FIG. 6 illustrates an HTM constructed according to the principles of the invention and forming part of an HTM acoustic model. The HTM includes a first tying structure. The first tying structure ties weighted Gaussian distributions in a first pool 610 to a first group of phones 630. In the embodiment of FIG. 6, the first tying structure is a generalized tied mixture, the first pool 610 is a pool of speech Gaussians, and the first group of phones 630 is a group of speech phones.

The HTM further includes a second tying structure. The second tying structure ties weighted Gaussian distributions in a second pool 620 to a second group of phones 640. The first tying structure differs from the second tying structure. The weighted Gaussian distributions in the first pool 610 are mutually exclusive of the weighted Gaussian distributions in the second pool 620. At least a criterion distinguishing the first group of phones 630 from the second group of phones 640.

In the embodiment of FIG. 6, the second tying structure is a state-tied mixture, the second pool 620 is a pool of nonspeech Gaussians, and the second group of phones 640 is a group of nonspeech phones. Accordingly, in the embodiment of FIG. 6, the criterion is a speech/nonspeech criterion. Those skilled in the pertinent art understand, however, that the first and second tying structures may be selected from the group consisting of: un-tied mixtures, fully tied mixtures, state-tied mixtures and generalized tied mixtures or may be any other conventional or later-developed tying structure.

Gaussians may be unique to each pool or may be available to multiple pools. Those skilled in the pertinent art will recognize, however, that the invention is not limited to two pools, to speech/nonspeech as being a criterion for dividing states into pools or to generalized tying or state-tying as being techniques for tying Gaussians to states.

Further, in one embodiment of the invention, different numbers of Gaussians can be tied to different states, advantageously based upon some characteristic of the state being tied. For example, some states may be tied to three Gaussians, others to four and still others to five or more Gaussians. Those skilled in the pertinent art will recognize, however, that the invention is not limited to particular numbers of Gaussians tied to states or to a particular criterion or criteria for deciding how many Gaussians should be tied to a state.

FIG. 7 illustrates a block diagram of one embodiment of a system for generating an acoustic model carried out according to the principles of the invention. The system may take the form of a sequence of software instructions executable in a DSP 700.

The system receives Gaussians and phones 710 that have been divided according to a criterion (e.g., speech/nonspeech). The system includes a first tyer 720. The first tyer 720 is configured to employ a first tying structure to tie weighted Gaussian distributions in a first pool to a first group of phones.

A second tyer 730 is associated with the first tyer 720. The second tyer 730 is configured to employ a second tying structure to tie weighted Gaussian distributions in a second pool to a second group of phones.

A pruner 740 is associated with the first tyer 720 and therefore the second tyer 730 by extension. The pruner 740 is configured to employ a characteristic to prune ties among the weighted Gaussian distributions in the first pool and the first group of phones to yield differing numbers of ties to ones of the first group of phones. The characteristic may be a weight magnitude, a distance or any other characteristic that may be found useful in a given application.

A retrainer 750 is associated with the pruner 740. The retrainer 750 is configured to adjust weights associated with the weighted Gaussian distributions after the pruner 740 prunes the ties. The result is an acoustic model 760 that may be stored in a memory device, which includes “embedding” the acoustic model 760 is a mobile communication device (e.g., 110a, 110b of FIG. 1).

FIG. 8 illustrates a flow diagram of one embodiment of a method of generating an acoustic model carried out according to the principles of the invention. The method begins in a start step. In a step 810, one or more criteria are employed to divide Gaussians and phones into multiple pools, in this case corresponding first and second pools and first and second groups. In a step 820, a first tying structure is employed to tie weighted Gaussian distributions in the first pool to a first group of phones. In a step 830, a second tying structure is employed to tie weighted Gaussian distributions in the second pool to a second group of phones. Again, the first tying structure differs from the second tying structure, the weighted Gaussian distributions in the first pool is mutually exclusive of the weighted Gaussian distributions in the second pool, and at least a criterion distinguishes the first group of phones from the second group of phones.

In a step 840, a characteristic is employed to prune ties among the weighted Gaussian distributions in the first pool and the first group of phones to yield differing numbers of ties to ones of the first group of phones. In a step 850, weights associated with the weighted Gaussian distributions are adjusted following the employing of the characteristic to prune ties. The method ends in an end step.

Having described several embodiments of systems and methods for generating an acoustic model according to the principles of the invention, some experiments involving a specific embodiment will now be set forth.

Experiments were performed to test the efficacy of one embodiment of the invention. In summary, it was found that employing HTM reduced the number of Gaussian mixture weights by 20%. Employing HTM also reduced the total number of mixture weights from 27K to 22K.

The specific ASR task performed in the experiments was speaker-independent name dialing (SIND), carried out with a hands-free microphone of a mobile communication device (e.g., a cellphone) in an automobile under three typical driving conditions: highway driving, stop-and-go (city) driving and parked. The experiments emphasized ASR performance during highway driving, because highway driving is generally regarded as a challenging condition in which to conduct ASR. Word error rate (WER) is a widely accepted metric for determining ASR performance and therefore was employed in the experiments.

TABLE 1
WER of a GTM-HMM Versus an HTM-HMM
in a SIND hands-free ASR task.

| | Highway | Stop-and-Go | Parked |
|---|---|---|---|
| 4-Gaussian GTM-HMM | 5.01 | 0.88 | 0.16 |
| 4-Gaussian HTM-HMM | 3.87 | 0.86 | 0.24 |

Table 1, above, shows the improvement by using different constraints on nonspeech Gaussians and speech Gaussians during tying. The baseline models used in the experiments were trained from the well-known Wall Street Journal (WSJ) database using a conventional generalized tied mixture (GTM) HMM. Both GTM-HMM and HTM-HMM employed uniform, homogeneous tying of four Gaussians per phone. As Table 1 shows, HTM achieved a 22% error reduction in ASR conducted during highway driving.

TABLE 2
WERs With and Without Heterogeneous Gaussian Pruning.

| | Highway | Stop-and-Go | Parked |
|---|---|---|---|
| 4-Gaussian HTM-HMM | 2.20 | 0.63 | 0.49 |
| HTM-HMM with Heterogeneous | 2.02 | 0.37 | 0.37 |
| Pruning | | | |

Table 2, above, shows the improvement by applying heterogeneous Gaussian pruning. For Table 2, the baseline models were trained with the well-known PhoneBook database (see, Pitrelli, et: al., “PhoneBook: A Phonetically-Rich Isolated-Word Telephone-Speech Database,” in IEEE ICASSP, 1995). HTM achieved a further 10% WER reduction under highway driving. Other driving conditions improved as well, as is evident in Table 2.

Although embodiments of the invention have been described in detail, those skilled in the art should understand that they can make various changes, substitutions and alterations herein without departing from the scope of the invention in its broadest form.

What is claimed is:

1. A system for generating an acoustic model, comprising:
a first tyer configured to employ a first tying structure to tie weighted Gaussian distributions in a first pool to a first group of phones; and
a second tyer associated with said first tyer and configured to employ a second tying structure to tie weighted Gaussian distributions in a second pool to a second group of phones, said first tying structure differing from said second tying structure, said weighted Gaussian distributions in said first pool being mutually exclusive of said weighted Gaussian distributions in said second pool, at least a criterion distinguishing said first group of phones from said second group of phones.

2. The system as recited in claim 1 wherein said first tying structure and said second tying structure are selected from the group consisting of:
un-tied mixtures,
fully tied mixtures,
state-tied mixtures, and
generalized tied mixtures.

3. The system as recited in claim 1 wherein said weighted Gaussian distributions in said first pool correspond to speech phones and said weighted Gaussian distributions in said second pool correspond to nonspeech phones.

4. The system as recited in claim 1 wherein said criterion is a speech/nonspeech criterion.

5. The system as recited in claim 1 further comprising a pruner associated with said first tyer and configured to employ a characteristic to prune ties among said weighted Gaussian distributions in said first pool and said first group of phones to yield differing numbers of ties to ones of said first group of phones.

6. The system as recited in claim 5 wherein said characteristic is selected from the group consisting of:
a weight magnitude, and
a distance.

7. The system as recited in claim 5 further comprising a retrainer associated with said pruner and configured to adjust weights associated with said weighted Gaussian distributions after said pruner prunes said ties.

8. A method of generating an acoustic model, comprising:
employing a first tying structure to tie weighted Gaussian distributions in a first pool to a first group of phones; and
employing a second tying structure to tie weighted Gaussian distributions in a second pool to a second group of phones, said first tying structure differing from said second tying structure, said weighted Gaussian distributions in said first pool being mutually exclusive of said weighted Gaussian distributions in said second pool, at least a criterion distinguishing said first group of phones from said second group of phones.

9. The method as recited in claim 8 wherein said first tying structure and said second tying structure are selected from the group consisting of:
un-tied mixtures,
fully tied mixtures,
state-tied mixtures, and
generalized tied mixtures.

10. The method as recited in claim 8 wherein said weighted Gaussian distributions in said first pool correspond to speech phones and said weighted Gaussian distributions in said second pool correspond to nonspeech phones.

11. The method as recited in claim 8 wherein said criterion is a speech/nonspeech criterion.

12. The method as recited in claim 8 further comprising employing a characteristic to prune ties among said weighted Gaussian distributions in said first pool and said first group of phones to yield differing numbers of ties to ones of said first group of phones.

13. The method as recited in claim 12 wherein said characteristic is selected from the group consisting of:
a weight magnitude, and
a distance.

14. The method as recited in claim 12 further comprising adjusting weights associated with said weighted Gaussian distributions following said employing said characteristic to prune said ties.

15. A heterogeneously tied mixture (HTM) acoustic model, comprising:
a first tying structure that ties weighted Gaussian distributions in a first pool to a first group of phones; and
a second tying structure that ties weighted Gaussian distributions in a second pool to a second group of phones, said first tying structure differing from said second tying structure, said weighted Gaussian distributions in said first pool being mutually exclusive of said weighted Gaussian distributions in said second pool, at least a criterion distinguishing said first group of phones from said second group of phones.

16. The model as recited in claim 15 wherein said first tying structure and said second tying structure are selected from the group consisting of:
un-tied mixtures,
fully tied mixtures,
state-tied mixtures, and
generalized tied mixtures.

17. The model as recited in claim 15 wherein said weighted Gaussian distributions in said first pool correspond to speech phones and said weighted Gaussian distributions in said second pool correspond to nonspeech phones.

18. The model as recited in claim 15 wherein said criterion is a speech/nonspeech criterion.

19. The model as recited in claim 15 wherein said first tying structure contains differing numbers of ties to ones of said first group of phones.

20. The model as recited in claim 15 wherein said model has been retrained following pruning.
